(19) United States
(12) Patent Application Publication
(10) Pub. No.: US 2003/0165124 A1
(43) Pub. Date: Sep. 4, 2003

(54) SYSTEM AND METHOD FOR PERFORMING HANDOVERS BASED UPON LOCAL AREA NETWORK CONDITIONS

(76) Inventors: VLADIMIR ALPEROVICH, DALLAS, TX (US); RANJIT BHATIA, DALLAS, TX (US); ERIC VALENTINE, PLANO, TX (US)

Correspondence Address: JENKENS & GILCHRIST, PC, 1445 ROSS AVENUE, SUITE 3200, DALLAS, TX, 75202, US

(21) Appl. No.: 09/223,155

(22) Filed: Dec. 30, 1998

(51) Int. Cl. H04Q 7/24

(52) U.S. Cl. 370/331; 370/252

(57) ABSTRACT

A telecommunications system and method is disclosed for monitoring the activity within a local area network (LAN), and, if the LAN traffic levels are above a threshold level such that wireless speech quality drops below an acceptable level, a handover of mobile communications can be performed to either a non-LAN based umbrella cell, or to another cell associated with a different LAN. A monitoring application within an Access Node (AN) of the LAN monitors the LAN conditions through the LAN management system (LMS). Based upon the information obtained from LMS, the new monitoring application in the AN can request a handover to be performed from the LAN based network to either the non-LAN umbrella cell or to another cell associated with another LAN system. Thus, the speech quality of mobile communications can be maintained in periods of high LAN traffic, and the load on the LAN can be maintained without adding further congestion due to mobile communications.

### BACKGROUND OF THE PRESENT INVENTION

1. Field of the Invention

The present invention relates generally to local area network (LAN) based wireless telecommunications systems, and specifically to ensuring adequate speech quality for mobile communications over LAN based wireless systems utilizing internet protocol routing procedures.

1. Background and Objects of the Present Invention

The first Local Area Networks (LANS) were proprietary and developed to support unintelligent user workstations in which a primary station controlled the operations of the attached devices (secondary stations). The effectiveness of this technology decreased because the master/slave protocol was too slow and cumbersome. Therefore, new types of LANs were developed, such as Ethernet LANs and token-ring LANs. Ethernet LANs and token-ring LANs are designed for data applications and use a shared medium (bus or ring, respectively) designed for 10 Mbit/s speeds and up to Gigabit speeds.

However, during periods of high activity, the shared medium does not respond well to all users, which results in degraded response time and throughput. Therefore, Switched Ethernet LANs were developed to provide more capacity to the end users. Switched Ethernet does not rely on sharing the media. Instead, Switched Ethernet provides point-to-point bandwidth between the user station and a switch. Another type of LAN being developed alongside Switched Ethernet is the Asynchronous Transfer Mode (ATM) based LAN, which utilizes very high-speed ATM switches that support multimedia applications.

On top of these different networking architectures, such as Switched Ethernet or ATM, which define the physical attributes of the communications network, many LANs have begun using Internet Protocol (IP) to route data between hosts on the network. The data is routed in datagrams and is transmitted using connection-less network services. Therefore, IP does not guarantee the reliable delivery of the data or the sequencing of the datagram. Hence, an upper layer, such as Transmission Control Protocol (TCP) or User Datagram Protocol (UDP), must provide this function. TCP connection-oriented services provide reliable delivery of data between the host computers by establishing a connection before the applications send data. Thus, TCP guarantees that the data is error free and in sequence. On the other hand, UDP connection-oriented services are used by various applications to send messages where the integrity of the data is not as important.

Data can be sent across a LAN from an originating host computer to a receiving host computer using the IP routing protocol by encapsulating the data sent by the originating host computer into an IP datagram, which includes an IP header. The IP header identifies the address of the receiving host computer. The IP datagram and header can then be further encapsulated into the specific protocol of the transit network, such as an Ethernet LAN, for delivery of the IP datagram and header to an IP router.

After the transit network has delivered the IP datagram and header to the IP router, the IP router strips away the control information and uses the destination address in the datagram header to determine where to route the traffic. Typically, the IP router then passes the datagram back to the sub-network by invoking a sub-network access protocol, such as Ethernet on the LAN. This protocol is used to encapsulate the datagram header and user data into the headers and trailers that are used by the sub-network to deliver the data to the receiving host computer. It should be understood that routers can also be used to transport data to other LANs or WANs.

LANs not only interconnect computers for data communications, but can also interconnect mobile terminals for voice communications. FIG. 1 depicts the implementation of a mobile communications system into a LAN 100. The mobile communications system includes an Access Node (AN) 130, which combines a Mobile Switching Center (MSC) functionality 134 for controlling calls made to and from Mobile Stations (MSs) 145 within the LAN 100 and a Base Station Controller (BSC) functionality 132 for controlling radio-related functions, such as channel assignment. The mobile communications system also includes at least one Base Transceiver Station (BTS) 140, which operates as a tranceiver for transmitting and receiving voice and control messages to and from the MSs 145, and an associated A-bis Gateway 142, which converts between circuit-switched signaling used by the BTS 140 and packet-switched signaling used by the LAN 100. The AN 130 and A-bis gateway 142 are connected to the LAN 100 through an LAN backbone 110.

The LAN 100 is managed through an LAN management system (LMS) 120 such as Tivoli or other similar system, which monitors the traffic and load on the LAN backbone 110. A gatekeeper 180 allocates bandwidth for all hosts, e.g., computers 125 and BTSs 140, on the LAN backbone 110 using, for example, the H.323 protocol. It should be noted that the LMS 120 can be included within the gatekeeper 180.

Wireless voice communications are transported through the LAN backbone 110 between BTSs 140 or between a BTS 140 and a Public Gateway (PG) 150 via UDP/IP. The PG 150 provides the interconnection between the packet based LAN 100 and the circuit switched public telephone network, e.g., Public Switched Telephone Network (PSTN) and Public Land Telephone Network (PLMN) 160. In many cases, a PLMN cell 192 overlaps the LAN 100. Speech and data are transmitted within the LAN 100 and through the Internet 175 using an IP Router 170.

In the IP based LAN wireless system 100, the BTSs 140 and the Access node 130 communicate with each other through the LAN backbone 110. In addition, the LAN backbone 110 is used by all other hosts 125, e.g., computers, in the network 100 to send and receive data communications between each other and through the Internet 175 via the IP Router 170. Therefore, when the LAN backbone 110 becomes congested, which can occur, for example, when a computer host 125 is downloading a large file, voice packets sent via the unreliable UDP can be delayed and eventually discarded, resulting in a decline in speech quality.

It is, therefore, an object of the present invention to monitor the LAN activity, and, if the performance degrades below an acceptable level, perform a handover of mobile communications to either a non-LAN based umbrella cell, or to another cell connected to a different LAN.

### SUMMARY OF THE INVENTION

The present invention is directed to telecommunications systems and methods for monitoring the activity in an LAN, and, if the LAN becomes congested such that wireless speech quality drops below an acceptable level, a handover of mobile communications can be performed to either a non-LAN based umbrella cell, or to another cell associated with a different, less-congested LAN. A new monitoring application within an Access Node (AN) of the LAN can monitor the LAN conditions through the LAN management system (LMS). Based upon the information obtained from LMS, the new monitoring application in the AN can request a handover to be performed from the LAN based network to either the non-LAN umbrella cell or to another cell associated with another LAN system. Thus, the speech quality of mobile communications can be maintained in periods of high LAN traffic, and the load on the LAN can be maintained without adding further congestion due to mobile communications.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a block diagram of a conventional internet protocol based local area network that provides mobile communications;

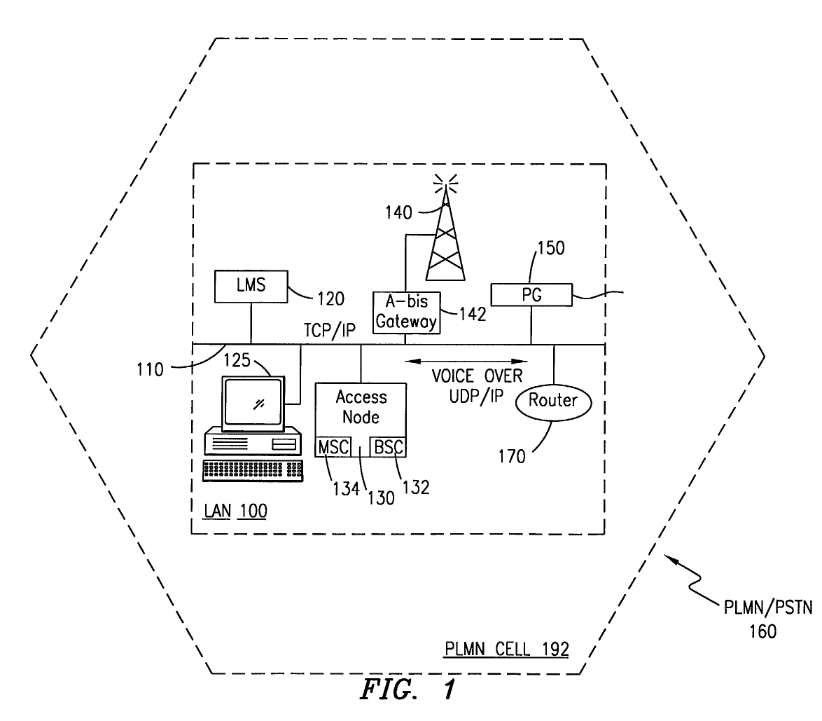

FIG. 2 illustrates a wireless system implemented on an internet based local area network in accordance with preferred embodiments of the present invention;

FIG. 3 illustrates a sample handover from a cell associated with a local area network based wireless system to an umbrella cell within the Public Land Mobile Network in accordance with sample embodiments of the present invention; and

FIG. 4 shows steps for performing the handover illustrated in FIG. 3.

### DETAILED DESCRIPTION OF THE PRESENTLY PREFERRED EXEMPLARY EMBODIMENTS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

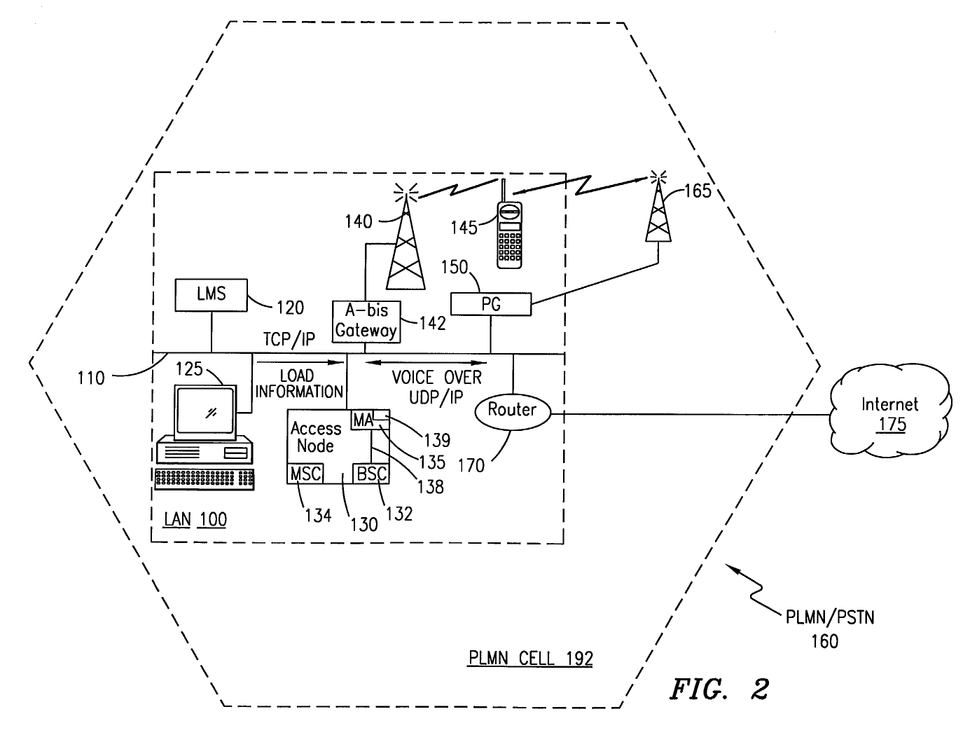

With reference now to FIG. 2 of the drawings, a Local Area Network (LAN) based wireless system 100 utilizing Internet Protocol (IP) routing procedures is shown in accordance with the teachings of the present invention. The traffic and load on the LAN backbone 110 due to voice and data communications is monitored by an LAN management system (LMS) 120. The host computer 125, Access Node (AN) 130, which is a combined Mobile Switching Center (MSC) 134 and Base Station Controller (BSC) 132, and Base Transceiver Stations (BTSs) 140 are all connected to the LAN backbone 110. It should be noted that the BTSs 140 are connected to the LAN backbone 110 through associated A-bis Gateways 142. When a Mobile Station (MS) 145 in wireless communication with one of the BTSs 140 makes or receives a call, the speech is transported through the LAN backbone 110 to another BTS (not shown) (if the calling or called party is another MS in wireless communication with another BTS connected to the LAN backbone 110) or to a Public Gateway 150, which provides the interconnection between the packet based LAN 100 and circuit switched public telephone network (if the calling or called party is within the PSTN/PLMN 160), the latter being illustrated. The speech is routed through the LAN backbone 110 using User Datagram Protocol (UDP) over IP. Speech is not routed using the more reliable Transmission Control Protocol (TCP) over IP. Speech and data are transmitted to the nodes, such as computer 125 and BTS 140, within the LAN 100 and through the Internet 175 using the IP Router 170.

In order to ensure that the speech quality remains acceptable for MSs 145 within the LAN 100, a new monitoring application 135 within the AN 130 monitors the LAN conditions through the LMS 120. The protocol used between the new monitoring application 135 in the AN 130 and LMS 120 can be, for example, Simple Network Management Protocol (SNMP) via the LAN backbone 110.

In a typical Ethernet LAN 100, each station (computer 125 or BTS 140) sees all of the transmissions on the LAN backbone 110. Therefore, prior to sending a transmission, for example, voice packets over UDP/IP, the BTS 140 must first “listen” to determine whether the LAN backbone 110 is busy. If the LAN backbone 110 is busy, the BTS 140 must wait to send its transmission until the LAN backbone 110 is silent. Therefore, the more traffic (load) on the LAN backbone 110, the longer the BTS 140 must wait and the more likely it is that the voice packets will be delayed and eventually discarded, both of which can significantly reduce the speech quality. Thus, the load is closely monitored by the LMS 120 and this information is sent to the monitoring functionality 135 within the AN 130 to determine whether adequate speech quality can be provided over the LAN 100.

Based upon the information obtained from the LMS 120, the new monitoring application 135 within the AN 130 can determine whether the load on the LAN backbone 110 has increased above a threshold load 139, e.g., 30 percent of the available bandwidth, which can be stored within the access node 130. The threshold load 139 can be set by the network operator based upon the speech quality at various load levels. If the load on the LAN backbone 110 is above the threshold load 139, the monitoring functionality 135 within the AN 130 can request a handover to be performed from the BTS 140 within the LAN based network 100 to a BTS 165 serving an overlapping cell 192 within either the PLMN network 160 or another, less-congested LAN based network (not shown) for mobile communications, the former being illustrated. The monitoring application 135 within the AN 130 can use a new interface 138 between the monitoring application 135 and the BSC 132 within the AN 130 to request such a handover.

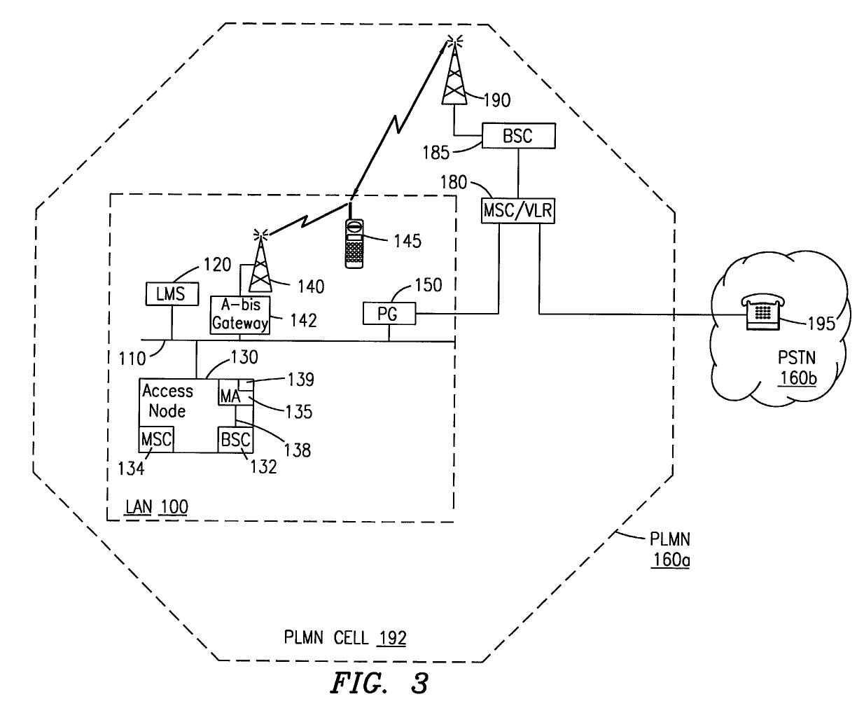

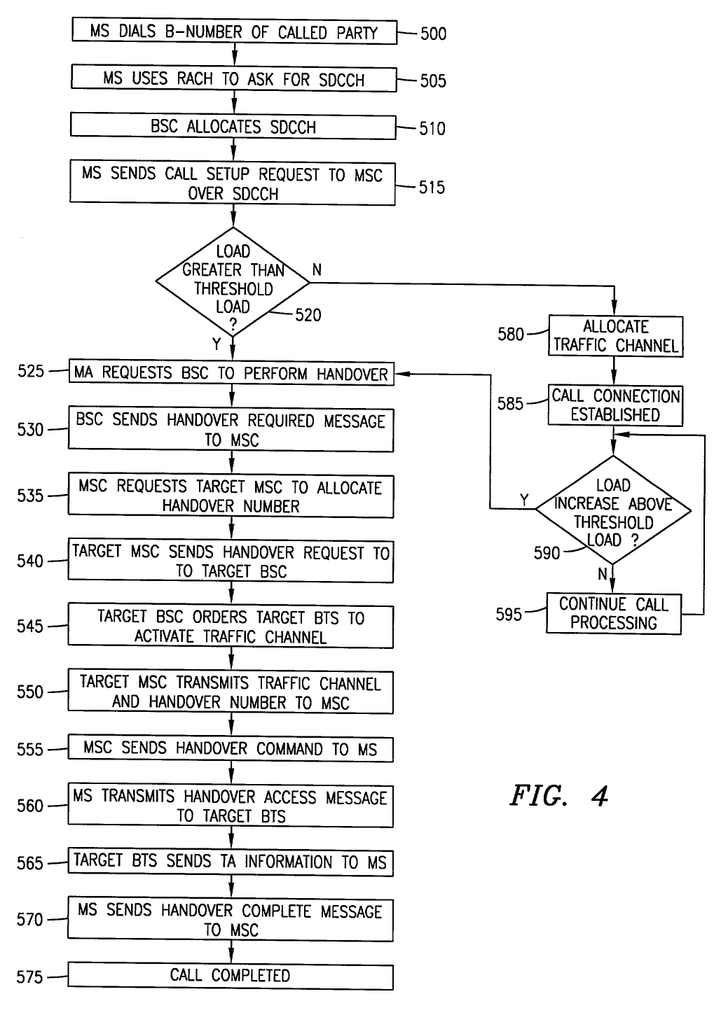

As an example, FIGS. 3 and 4 illustrate the handover of a call placed by an MS 145 within the LAN 100 to an umbrella cell 192 within the PLMN 160a. When a mobile subscriber attempts to place a call to a called party 195 within, for example, the PSTN 160b, the mobile subscriber dials a B-number associated with the called party 195 and presses “Send” or another similar function key on the MS 145 (step 500). The MS 145 uses the Random Access Channel (RACH) to ask for a signaling channel, such as a Stand Alone Dedicated Control Channel (SDCCH) (step 505). The BSC functionality 132 within the AN 130 allocates a signaling channel (step 510), and the MS 145 uses this channel to send a call setup request to the MSC functionality 134 within the AN 130 (step 515). All signaling information preceding the call is sent over this allocated signaling channel. For example, the MS 145 sends the dialed B-number over this signaling channel to the MSC functionality 134 within the AN 130.

At this point, the MSC functionality 134 within the AN 130 typically requests the BSC functionality 132 within the AN 130 to allocate a free traffic channel (step 580), which is forwarded to the serving BTS 140 and the MS 145 to activate the allocated traffic channel, and a call connection is established between the MS 145 and the called party 195 (step 585). However, if the load on the LAN backbone 110 has increased above the established threshold load 139 based upon information provided by the LMS 120 (step 520), the monitoring functionality 135 within the AN 130 can request the BSC functionality 132 within the AN 130 via the BSC interface 138 to perform a handover to an umbrella cell 192 within the PLMN 160a (step 525) prior to allocating a traffic channel in order to ensure adequate speech quality and to prevent further increasing of the load on the LAN backbone 110.

The handover is performed by the BSC functionality 132 within the AN 130 sending a handover required message to the MSC functionality 134 within the AN 130 (step 530), together with the identity of the target cell 192 (in this case an umbrella cell 192 within the PLMN 160a). The MSC 134 functionality within the AN 130 realizes that the target cell 192 belongs to another MSC 180 and requests the target MSC 180 to allocate a handover number in order to reroute the call (step 535). The target MSC 180 sends a handover request to the new target BSC 185 (step 540), which orders the target BTS 190 to activate a traffic channel (step 545). The target MSC 180 receives the traffic channel information and passes this information along with the handover number to the MSC functionality 134 within the AN 130 (step 550).

The MSC functionality 134 within the AN 130 sends a handover command to the MS 145 via the BSC 132 functionality (step 555), which contains information regarding the frequency and time slot of the new allocated traffic channel. The MS 145 tunes to the new frequency and transmits a handover access message to the target BTS 190 (step 560). The target BTS 190 sends the MS 145 information about the Timing Advance (step 565), which is the amount of time the MS 145 must send information in advance of its assigned time slot in order for the information to be received by the BTS 190 in the assigned time slot. Once the handover is complete, the MS 145 sends a handover complete message to the MSC functionality 134 within the AN 130 via the target BSC 185 and MSC 180 within the PLMN 160a (step 570). The call can then be completed to the called party 195 and voice communications can then be sent through the new MSC 180, BSC 185 and BTS 190 (step 575). Thus, the speech quality of mobile communications can be maintained in periods of high LAN 100 traffic, and the load on the LAN backbone 110 can be maintained without adding further congestion due to mobile voice communications.

However, if the load has not increased above the threshold load 139 (step 520), the monitoring application 135 within the AN 130 will not request a handover to the umbrella cell 192 within the PLMN 160a (step 525). Instead, the MSC functionality 134 within the AN 130 requests the BSC functionality 132 within the AN 130 to allocate a traffic channel (step 580) and the MSC functionality 134 within the AN 130 establishes a call connection between the calling MS 145 and the called party 195 via the public gateway 150 (step 585). Voice packets can then be sent on the LAN backbone 110 between the serving BTS 140 and the public gateway 150 using UDP/IP.

It should be understood that the monitoring application 135 within the AN 130 continues to monitor the load on the LAN backbone 110 throughout the duration of the call (step 590). If the load does not increase above the threshold load 139 (step 590), the call continues normally through the LAN backbone 110 (step 595). However, if the load does increase above the threshold load 139 during the call (step 590), the monitoring application 135 within the AN 130 requests the BSC functionality 132 within the AN 130 via the BSC interface 138 to perform a handover to the umbrella cell 192 within the PLMN 160a (step 525). The handover is then completed as stated hereinbefore (steps 530-575). It should be noted that the handover can be performed to an adjacent or overlapping cell within another LAN (not shown) instead of to the umbrella cell 192 within the PLMN 160a. The additional LAN can be associated with the original LAN 100 (both owned and operated by the same company) or an agreement can exist between the LANs 100 allowing such handovers to be performed. In addition, it should be understood that if the target cell 192 cannot accept the handover due to high traffic in that cell 192, the handover will not be performed.

In addition, in an alternative embodiment of the present invention, if the MS 145 has received an incoming call, and the monitoring application 135 within the AN 130 determines that the load has increased above the threshold load 139, the monitoring application 135 within the AN 130 requests the BSC functionality 132 within the AN 130 via the BSC interface 138 to perform a handover to the umbrella cell 192 within the PLMN 160a or to another LAN. The handover is then completed as stated hereinbefore.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

What is claimed is:

1. A local area network based wireless telecommunications system, comprising:
a base station functionality for providing wireless communication with a mobile station, said mobile station being involved in a call connection; and
an access node associated with said base station functionality, said access node monitoring the traffic load on said local area network, said access node initiating a handover of said call connection of said mobile station to a second base station within a second wireless telecommunications network when the traffic load on said local area network increases above a threshold traffic load.

2. The local area network of claim 1, further comprising a local area network management system connected to said access node over said local area network, said local area network management system providing traffic load information on said local area network to said access node.

3. The local area network of claim 2, wherein said access node compares said traffic load information to said threshold load, said access node initiating said handover when said traffic load information is above said threshold load.

4. The local area network of claim 3, further comprising an interface enabling said access node to instruct said base station functionality to perform said handover.

5. The local area network of claim 3, further comprising mobile switching center functionality within said access node.

6. The local area network of claim 5, wherein said handover is performed by said mobile switching center functionality within said access node requesting a target mobile switching center within said second wireless telecommunications network to transmit a handover number to said mobile switching center functionality, said mobile switching center functionality within said access node using said handover number to instruct said mobile station to transmit a handover message to said second base station within said second wireless telecommunications network.

7. The local area network of claim 1, further comprising
a base transceiver station connected to said access node over said local area network; and
a gateway connected to said base transceiver station over said local area network, voice packets being transmitted between said base transceiver station and said gateway via user datagram protocol over internet protocol.

8. The local area network of claim 7, wherein said base station functionality is within said access node, and further comprising a local area network backbone for connecting said access node and said base transceiver station over said local area network.

9. The local area network of claim 1, wherein said second wireless telecommunications network is the Public Land Mobile Network.

10. The local area network of claim 1, wherein said second wireless telecommunications network is an additional local area network.

11. The local area network of claim 1, wherein said base station functionality within said local area network serves a first cell, said second base station serving a second cell overlapping said first cell.

12. An access node within a local area network based wireless telecommunications system, comprising:
mobile switching center functionality for controlling wireless communications of at least one mobile station within said local area network;
base station controller functionality in communication with said mobile switching center functionality and said mobile station;
means for receiving traffic load information relating to the load on said local area network; and
means for monitoring said traffic load information, said monitoring means comparing said traffic load information to a threshold load, said monitoring means instructing said base station controller functionality to perform a handover of said wireless communications of said mobile station to a second base station within a second wireless telecommunications network when said traffic load information is greater than said threshold load.

13. The access node of claim 12, further comprising an interface enabling said monitoring means to instruct said base station controller functionality to perform said handover.

14. The access node of claim 12, wherein said handover is performed by said mobile switching center functionality requesting a target mobile switching center within said second wireless telecommunications network to transmit a handover number to said mobile switching center functionality, said mobile switching center functionality within said access node using said handover number to instruct said mobile station to transmit a handover message to said second base station within said second wireless telecommunications network.

15. A method for providing a call connection from a local area network based wireless telecommunications system to a second wireless telecommunications network, said method comprising the steps of:
establishing a threshold load for said local area network based wireless telecommunications system, said threshold load being stored in an access node of said local area network;
sending a call setup request from a mobile station in wireless communication with base station functionality within said local area network to said access node via said base station functionality;
monitoring the traffic load on said local area network;
comparing the traffic load on said local area network with said threshold load; and
performing a handover of said call setup request of said mobile station from said base station functionality of said local area network to a second base station within said second wireless telecommunications network when the traffic load on said local area network is greater than said threshold load.

16. The method of claim 15, further comprising the step of:
providing, by a local area network management system connected to said access node over said local area network, traffic load information to said access node, said step of comparing being performed by comparing, by said access node, said traffic load information to said threshold load.

17. The method of claim 16, wherein said base station functionality is within said access node, and further comprising the step of:
instructing said base station functionality within said access node via an interface to perform said handover when said traffic load information is above said threshold load.

18. The method of claim 15, wherein said step of performing further comprises the steps of:
requesting, by mobile switching center functionality within said access node, a target mobile switching center within said second wireless telecommunications network to transmit a handover number to said mobile switching center functionality; and
using, by said mobile switching center functionality within said access node, said handover number to instruct said mobile station to transmit a handover message to said second base station within said second wireless telecommunications network.

20. A method for providing a call connection from a local area network based wireless telecommunications system to a second wireless telecommunications network, said method comprising the steps of:
stablishing a threshold load for said local area network based wireless telecommunications system, said threshold load being stored in an access node of said local area network;
establishing said call connection between a mobile station in wireless communication with base station functionality within said local area network and another subscriber;
monitoring the traffic load on said local area network;
comparing the traffic load on said local area network with said threshold load; and
performing a handover of said call connection from said base station functionality of said local area network to a second base station within said second wireless telecommunications network when the traffic load on said local area network is greater than said threshold load.

21. The method of claim 20, further comprising the step of:
providing, by a local area network management system connected to said access node over said local area network, traffic load information to said access node, said step of comparing being performed by comparing, by said access node, said traffic load information to said threshold load.

22. The method of claim 21, wherein said base station functionality is within said access node, and further comprising the step of:
instructing said base station functionality within said access node via an interface to perform said handover when said traffic load information is above said threshold load.

23. The method of claim 20, wherein said step of performing further comprises the steps of:
requesting, by mobile switching center functionality within said access node, a target mobile switching center within said second wireless telecommunications network to transmit a handover number to said mobile switching center functionality; and
using, by said mobile switching center functionality within said access node, said handover number to instruct said mobile station to transmit a handover message to said second base station within said second wireless telecommunications network.
